(19) United States
(12) Patent Application Publication
(10) Pub. No.: US 2014/0359637 A1
(43) Pub. Date: Dec. 4, 2014

(54) TASK CONTINUANCE ACROSS DEVICES

(71) Applicant: Microsoft Corporation, Redmond, WA (US)

(72) Inventor: An Yan, Beijing (CN)

(21) Appl. No.: 13/908,468

(22) Filed: Jun. 3, 2013

(51) Int. Cl. G06F 9/48

(52) U.S. Cl. CPC G06F 9/4881
USPC 718/108

(57) ABSTRACT

Architecture that facilitates a user experience for continuing computer and/or application tasks across user devices. Task status can be synchronized across devices via a cloud service or via a short-range wireless peer-to-peer (P2P). When applied to searching, for example, the user experience enables users to resume the same search session across devices in several ways. The disclosed architecture can also be extended to other tasks such as web browsing, online meetings, office application sessions, etc. The client application of each device collects the states of each application (e.g., document links, websites, online meeting information, etc.) as part of the synchronization, and uses the states to resume the same applications on different devices (e.g., open the same word processing document, a browser to the same websites, re-join online meetings, etc.).

### BACKGROUND

It is common for users to switch devices (e.g., desktop, laptop, mobile phone) multiple times throughout the day, but want to continue with the same task. For example, a user may search a restaurant on a desktop computing system before leaving home, and then continue the commute/map search on the mobile phone while traveling to the restaurant. Continuing such tasks from one device to another device requires manual interaction such as inputting in the same query originally input on the first device, on the new device.

In addition to search, there are other tasks that users may want to continue on another device. For example, a user may need to change locations (and hence, devices) during an online call, but want to rejoin the same conversation on anther device (e.g., phone). In another example, a user may find a movie on a phone search application, and then want to switch to a desktop computer to view the movie. In these scenarios, however, continuing such tasks across device requires additional work such as copying files, opening a file and browsing to the same page, re-typing the website, finding the online meeting and rejoining, etc.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates a user experience for continuing computer and/or application tasks across user devices. The tasks can be searching, browsing, or other office application activities, for example. Task status can be synchronized across devices via a cloud service or via a short-range wireless peer-to-peer (P2P) connection such as Bluetooth™.

When applied to searching, for example, the user experience enables users to resume the same search session across devices in several ways. A first way to accomplish task continuance of a search session and other session types is using cloud services (e.g., online data storage, online data sharing, other services such as search engines) to synchronize search history.

A second way to accomplish task continuance is via a P2P connection (e.g., short-range wireless or wired). Continuing with the search example, search history can be copied P2P via a Bluetooth connection.

The disclosed architecture can also be extended to other tasks such as web browsing, online meetings, office application sessions, etc. The client application of each device collects the states of each application (e.g., document links, websites, online meeting information, etc.) as part of the synchronization, and uses the states to resume the same applications on different devices (e.g., open the same word processing document, a browser to the same websites, re-join online meetings, etc.).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a task resumption system in accordance with the disclosed architecture.

FIG. 2 illustrates a more detailed task resumption system in accordance with the disclosed architecture.

FIG. 3 illustrates example user interfaces for selection of one or more tasks on one device and continuation of those tasks on another device.

FIG. 4 illustrates a cloud service for task continuation on devices.

FIG. 5 illustrates a method in accordance with the disclosed architecture.

FIG. 6 illustrates an alternative method in accordance with the disclosed architecture.

FIG. 7 illustrates a block diagram of a computing system that executes task continuation in accordance with the disclosed architecture.

### DETAILED DESCRIPTION

The disclosed architecture facilitates a user experience for continuing computer and/or application tasks (e.g., “tap and continue tasks”) across user devices. The tasks can be searching, browsing, or other office application activities, for example. Task status can be synchronized across devices via a cloud service or via a short-range wireless peer-to-peer (P2P) connection such as Bluetooth™.

More specifically, when applied to searching, the user experience enables users to resume the same search session, for example, across devices in several ways. A first way to accomplish task continuance of a search session and other session types is using cloud services (e.g., online data storage, online data sharing, other services such as search engines) to synchronize search history. Each user device installs a client application (or is an add-on component to an existing application).

All the clients log-in to the cloud service via a same user ID (e.g., a Windows Live™ identifier (ID), a social network ID, etc.). When the user is leaving a device, the user interacts with the installed client application to select one or more tasks (e.g., search history, browse session, etc.) to continue across devices. This selection can be performed on-demand, and/or pre-configured to be automatic. The other user devices receive a notification and prompt the user to elect resumption (e.g., “tap and continue”) of the one or more tasks. When user responds on another device, the client application opens (launches) the necessary applications (e.g., a browser, and add-on program, etc.) and resumes the same state of each related application (e.g., issues the same queries, opens the same website, etc.).

A second way to accomplish task continuance is via a P2P connection (e.g., short-range wireless or wired). Continuing with the search example, search history can be copied P2P via a Bluetooth connection. Compared to the cloud-based solution, the P2P solution is easier to implement, but for a wireless connection, requires the two devices to remain in close proximity during the task context transfer.

The disclosed architecture also finds application to a browser extension toolbar, a search “charm” (a Windows 8™ operating system feature), browsers (e.g., Internet Explorer™), or other client applications. The disclosed architecture can also be extended to other tasks such as web browsing, online meetings, office application sessions, etc. The client application (e.g., client 108) collects the states of each application (e.g., document links, websites, online meeting information, etc.) as part of the synchronization, and uses the states to resume the same applications on different devices (e.g., open the same word processing document, a browser to the same websites, re-join online meetings, etc.).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

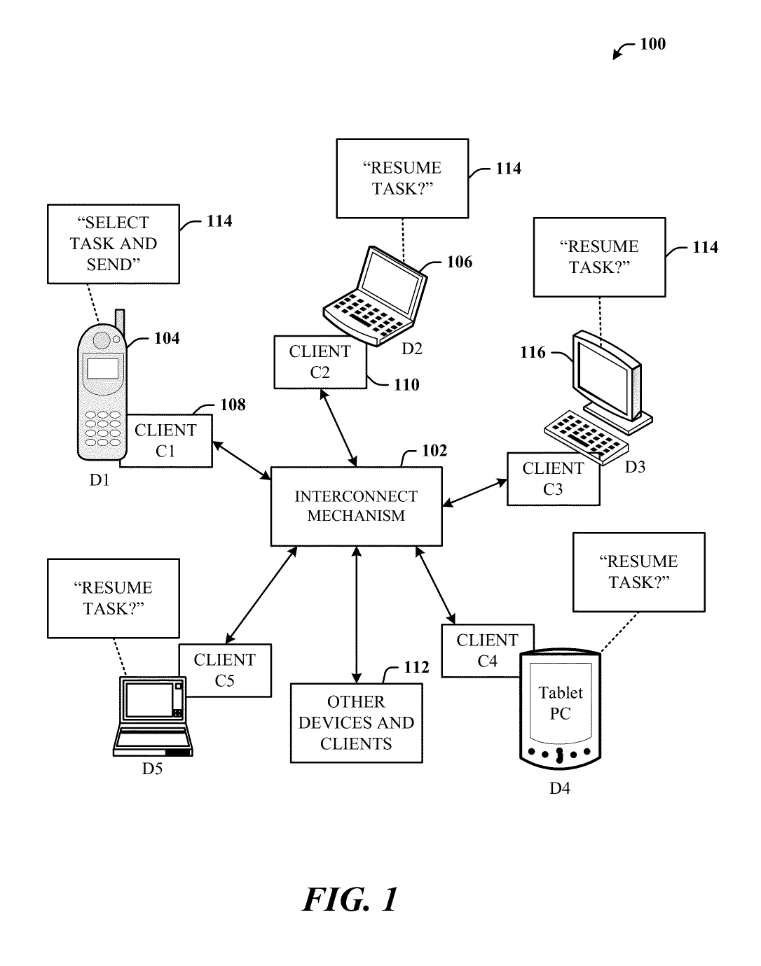

FIG. 1 illustrates a task resumption system 100 in accordance with the disclosed architecture. The system 100 facilitates the resumption of a task (or tasks) of a first device, for first device (D1) 104, on a second device, for example, a second device (D2) 106. In support thereof, the system 100 comprises an interconnect mechanism 102 (e.g., a wireless short-range technology (e.g., Bluetooth), a cloud service, etc.) and device clients (e.g., a first device client (C1) 108 of the first device 104, a second device client (C2) 110 of the second device 106, etc.) that enable the communication of data and signals between the devices (and clients) for task resumption.

The clients (e.g., client C1, C2, C3, etc.) operate in coordination with the device software (e.g., operating system, other applications, etc.) to enable task selection and then communication of the option to resume task processing on one or more other devices. The clients can be designed to operate compatibly with the specific devices on which the client is installed, and more specifically, only on devices common to a single user. For example, one client can operate compatibly on cell phones (e.g., the first device 104), another client designed to operate on computers (e.g., desktop device D3, laptop computing devices D2 and D5, and a tablet computer D4), and yet other clients designed to operate on other suitable devices 112.

In operation, a user performing one or more tasks (e.g., web search), on the first device 104 is enabled by the disclosed architecture to select the one or more tasks for resumption on the second device 106. The first client 108 operates with device software to present a user interface (UI) 114 for task selection/transfer and resumption.

User interaction with the first device 104, the first client 108, and the UI 114 can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Once presented with a “Select task and send” ability in the UI 114, the user can select the one or more tasks (partially completed, or interrelated task where a second task is only initiated after completion of a previous task), as facilitated by the UI 114 of the first device 104, then cause the process to execute (e.g., hitting a Send button) wherein all other user devices (D2, D3, D4, D5 and clients C2, C3, C4, C5) receive a notification (e.g., “Resume task?”) in the corresponding UIs 114. The user can then go to any of the other user devices (e.g., the second device 106 and interact with the notification (e.g., “Resume task?”) of the UI 114 to cause resumption of the one or more tasks on that second device 106. The second device 106 will launch all the applications it needs to resume the one or more tasks.

It can be the case that the user at the second device 106 can then choose to again move to a third device 116 for task resumption on the third device 116. The reasons for doing this can be due to time constraints (e.g., only had fifteen minutes to use before an unexpected interruption) in using the second device 106, resource constraints of the second device 106 (the third device 116 has more hardware resources than the second device 106), software performance limitations of the second device 106 (the third device 116 has more powerful software than the second device 106), and so on. In other words, the applications that may be performing the task(s) on the first device 104 may not be identical to the applications resuming the task(s) on the second device 106.

It can be the case that the system 100 performs a compatibility check between the application or applications used in the first device 104 to the application or applications available on the second device 106 for resuming the task(s). The compatibility check results can be provided during the selection process as a background operation so the user can know upfront which device may be more suitable or desirable for resuming the task(s).

As previously indicated, the interconnect mechanism 102 can be via a network cloud service, peer-to-peer (P2P) connection, or both. As a cloud service, the device hardware/software capabilities can be known and stored “in the cloud” such that the compatibility check is made against the device data stored in the cloud and accessible by network service. For the P2P connection, the clients can include the compatibility check capability, if desired to be implemented.

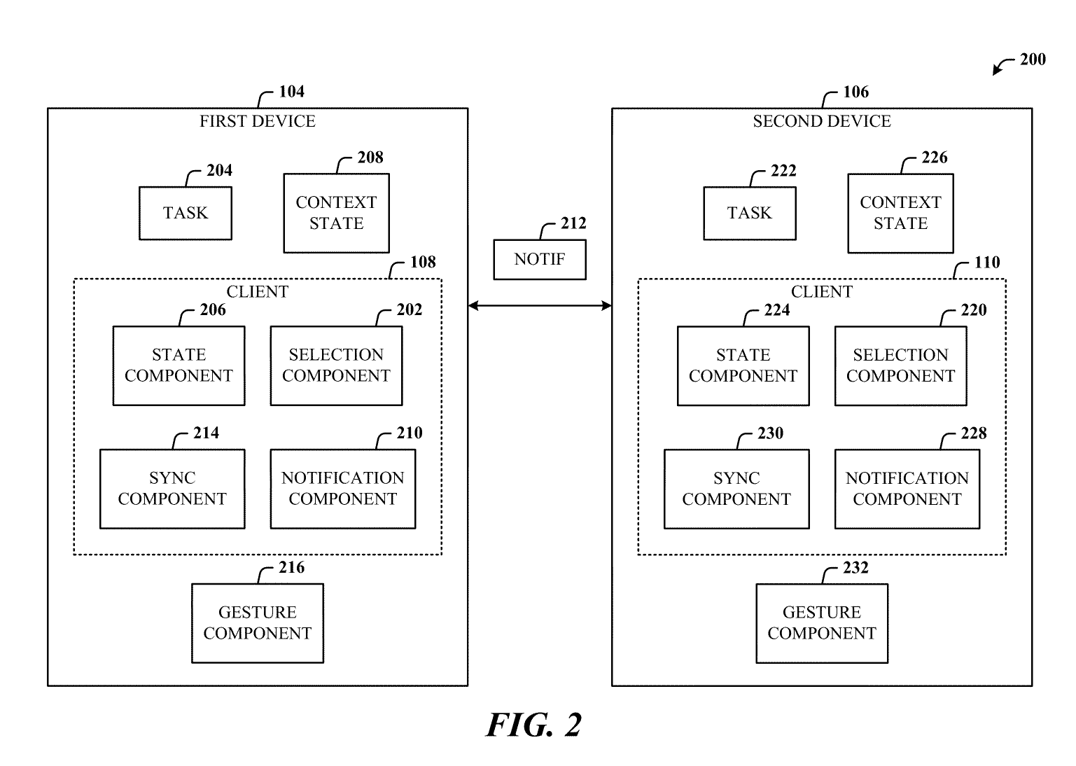

FIG. 2 illustrates a more detailed task resumption system 200 in accordance with the disclosed architecture. In this head-to-head illustration of FIG. 2, two devices are shown each with a client that enables the disclosed architecture: the first device 104 and associated first client 108, and the second device 106 and associated second client 110.

The first client 108 can include a selection component 202 that enables selection of a task 204 of the first device 104 to continue on the second device 106. A state component 206 captures context state 208 on the first device 104 associated with the task 204, based on the selection automatically made, or manually made (by the user). The context state 208 comprises the one or more applications, checkpoint state, and any other data, settings, signals, processes, etc., being utilized at or near the time of termination of the partially-completed task 204, and operating to facilitate completion of the task on the first device 104.

A notification component 210 sends a notification 212 (abbreviated as notif in FIG. 2) or other signal to the second device 106 to continue the task 204 on the second device 106. The notification 212 can include or further generate the interactive option (e.g., via a gesture) to accept the task resumption or decline the task resumption. The notification component 210 can also receive and process notifications (signals) from other devices to facilitate display of the notification on the local device. The synchronization (sync) component 214 synchronizes the context state received from another suitable device (e.g., the context state 208 of the first device 104) to the local state to resume the task previously running on the other device.

Similarly, the second client 110 of the second device 106 can include a selection component 220 that enables selection of a task 222 of the second device 106 to continue on the first device 104. A state component 224 captures context state 226 on the second device 106 associated with the task 222, based on the selection. The context state 226 comprises the one or more applications, checkpoint state, and any other data, settings, signals, processes, etc., being utilized at or near the time of termination of the partially-completed task 222, and operating to facilitate completion of the task 222 on the first device 104.

A notification component 228 can send a notification (or signal) (not shown) to the first device 104 to continue the task 222 on the first device 104. The notification can include or further generate the interactive option (e.g., via a gesture) to accept the task resumption or decline the task resumption. The notification component 228 can also receive and process notifications (signals) from other devices to facilitate display of the notification on the local device. The synchronization (sync) component 230 synchronizes context state 208 of the first device 104 to the local state to resume the task 204 on the second device 106.

It is to be understood that all user devices that operate in accordance with the disclosed architecture include a client (e.g., client 108) that enables the features described herein such as state capture (by the state component 206), selection (using the selection component 202, notification (using the notification component 210), and state synchronization (using a synchronization component 214), and possibly, gesture recognition (e.g., using the gesture component 216). A gesture component 232 interprets a received gesture to resume the task 204 on the second device 106.

In a one-way operation, the user chooses to select and resume (continue) the partially-completed task 204 of the first device 104, on the second device 106. Thus, the first client 108 facilitates the notification and capture of the context state 208 and transmission thereof to the second client 110 of the second device 106, either directly via the P2P connection or indirectly through the cloud service. When the notification 212 is received at the second device 106, the UI of the second device 106 displays the notification or a suitable implementation instruction to the user, who can elect (via a gesture such as a “tap” on the device display) to accept the continuation of the task 204.

Once elected, the synchronization component 230 receives and processes the context state 208, to synchronize (change) the current state of the second device 106 to the context state 208 of the first device 104. Thus, although not shown, the state of the second device 106 is configured to the context state 208 of the first device 104, to include starting all applications needed to achieve the context state 208. It can be the case that another notification is presented to the user that the context state has been achieved, in which case the user can then begin again at that point of the task 204.

In other words, the context state is captured locally in the first device and communicated via a network-based service to the second device. The context state is captured locally in the first device and communicated to the second device via a peer-to-peer connection. The context state is associated with multiple applications, and the multiple applications are launched on the second device to resume the task. The selection component automatically selects the task on the first device that is to be resumed on the second device. The gesture component recognizes the gesture as a natural user interface gesture to accept resumption of the task on the second device. The first device and the second device are commonly-identified by login credentials.

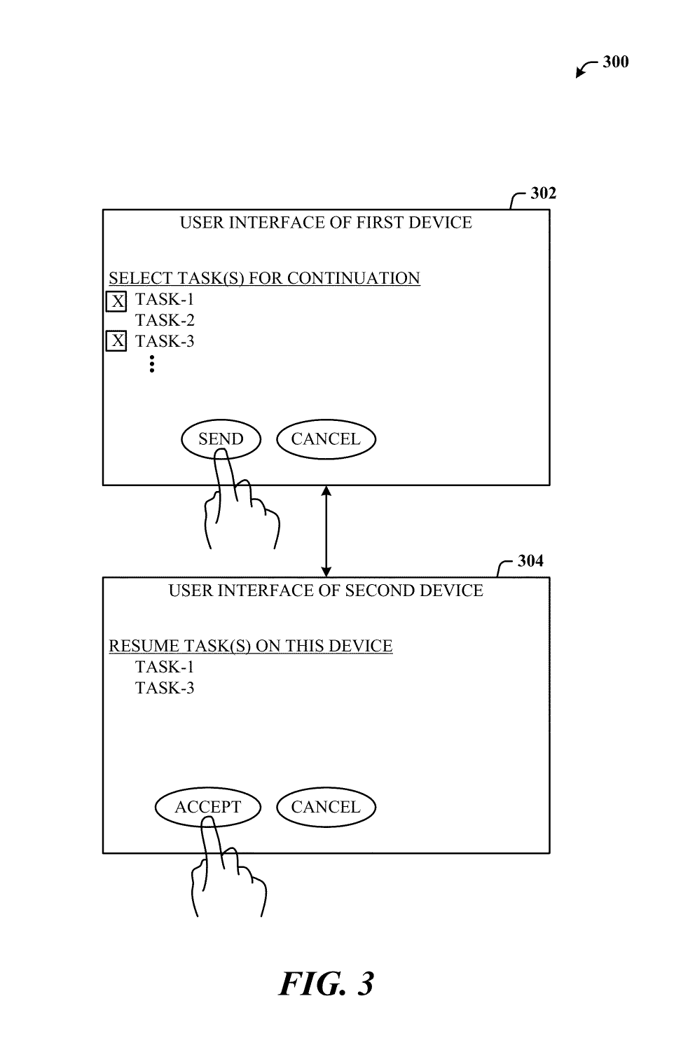

FIG. 3 illustrates example user interfaces 300 for selection of one or more tasks on one device and continuation of those tasks on another device. A first UI 302 (similar to UI 114) on the first device 104 provides the capability for the user to select one or more tasks currently in-process or recently having been in-process. Once selected, the context state is captured that defines the one or more applications associated with the task or tasks, as well as application data, checkpoint data, and any other data/information needed to reproduce the task state on the second device.

Here, the user interacts with a touch-screen display to select a first task (Task-1) and a third task (Task-3) for continuation on the second device. Thus, the selection component 202 enables the obtainment of the current tasks (e.g., from the device operating system and application logs), and facilitates the presentation, selection, and sending of the task information to generate not only the notification, but also to signal the destination device (e.g., the second device 106) of the intent to continue the task(s).

Once sent, the destination devices (e.g., the second device 106) receive the notification, as shown in the UI 304 of the second device 106. This UI 304 can simply show the tasks originally selected at the sending device (the first device 104) and provide the capability for the user to Accept and begin the task resumption process on the second device 106, using another interpretable or recognized gesture such as a touch. Once the state of the second device 106 reaches the context state of the first device 104, another notification can be presented to inform the user that resumption can now begin on the second device 106. It is to be understood that in accordance with the NUI technologies, the user and UI can employ any single or combination of technologies to interact with the UI to cause task selection and resumption initiation.

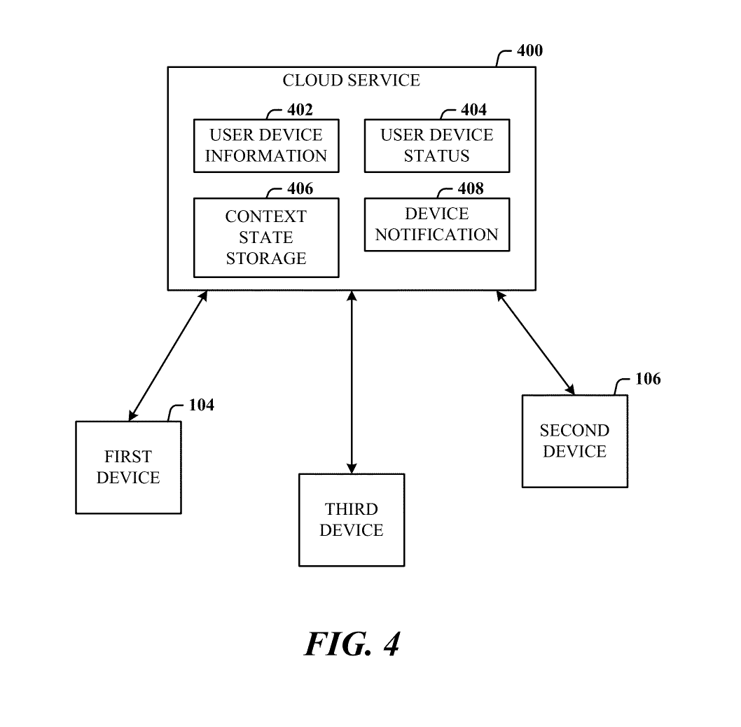

FIG. 4 illustrates a cloud service 400 for task continuation on devices. The service 400 can provide the capabilities to know the user device information 402, know what user devices are currently available online or accessible by some other communicative means via user device status 404, store context state 406, and provide device notification 408, for example.

The context state can be uploaded to the cloud service 400 from the first device 104 based on an inference that the user will want and eventually choose to resume task processing on a second device 106. For example, based on the time of day or an departure from the first device (e.g., as identifiable using geolocation (geographical location) information such as geographical latitude/longitude coordinates), the first device 104 can be configured to automatically capture the context state and upload the context state to the cloud service 400 for possible use by the user. Once the user accesses the second device 106, for example, the user will be provided with the option to resume task continuation at that time and on that device. If declined, the context state can be immediately deleted from the cloud service 400, or retained for a period of time for recreation at a later date. Thus, a historical record can be retained of the user activity.

The user device information 402 can record the minimum device information such as hardware/software capabilities, login information, user identity (ownership) information, and so on. The user device status 404 tracks the availability of the user devices at any point in time to only send notifications to available user devices, or to send only when the user devices becomes accessible.

It can be the case the service 400 also facilitates sending notifications to specific user devices and not all available user devices. This determination can be based on destination device capabilities, for example. When using this model, the user interface presents only a set of suggested devices on which the user should continue the task(s), or alternatively, can present all available devices but automatically indicates which devices are desired to be used for task continuation.

In yet another implementation, based on the task to be continued, the service 400 suggests specific devices to handle specific tasks. For example, if the task involves heavy modeling algorithms, task resumption may be desired on a desktop device rather than a smart phone due to the known performance capabilities of the desktop device.

It can be the case that the user interface also provides a listing of stored context state at the service 400 that can be accessed and resumed from any device and as desired. For example, rather than being a push model where the first device 104 pushes the task continuance intent to other devices, a pull model can be employed where the user can choose from any number of context state items stored in the service 400 to resume on an user device.

In yet another implementation, the context state captures the state of a specific application on the first device 104 and continues the context state of the same application on the second device 106.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

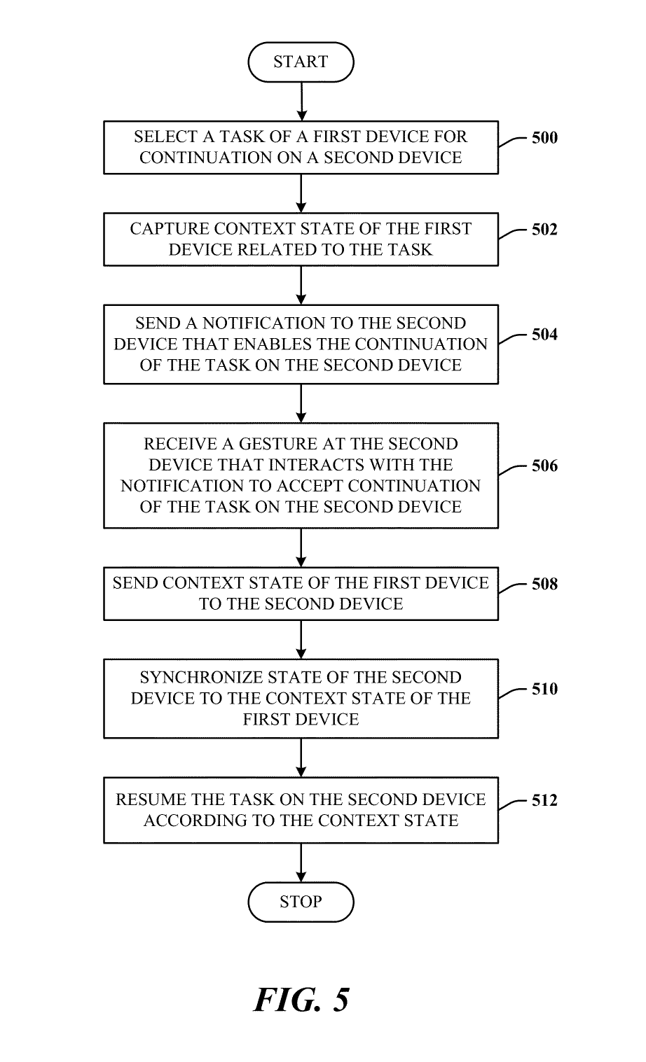

FIG. 5 illustrates a method in accordance with the disclosed architecture. At 500, a task of a first device is selected for continuation on a second device. At 502, context state of the first device related to the task is captured. At 504, a notification is sent to the second device that enables the continuation of the task on the second device. At 506, a gesture is received at the second device that interacts with the notification to accept continuation of the task on the second device. A gesture can also be employed on the first device to initiate the task continuation process. At 508, context state of the first device is sent to the second device. At 510, the state of the second device is synchronized to the context state of the first device. At 512, the task is resumed on the second device according to the context state.

The method can further comprise capturing checkpoint context as the context state or part of the context state of the first device. The method can further comprise sending the context state from the first device to the second device via short-range wireless communications connection (e.g., Bluetooth). The method can further comprise sending the context state and the notification to the second device via a network service (e.g., a cloud service). The method can further comprise recognizing the gesture as tactile contact with a touch display of the second device. The method can further comprise enabling automatic and/or manual selection of the task on the first device.

The method can further comprise sending the notification to the second device and other devices of a user, the second device and the other devices associated with the first device by a user login identifier. The method can further comprise automatically logging in a client application of each of the first device, the second device and the other devices to a network service for sending the notification and the context state. The method can further comprise launching one or more applications on the second device that define the context state of the first device, and resume the task.

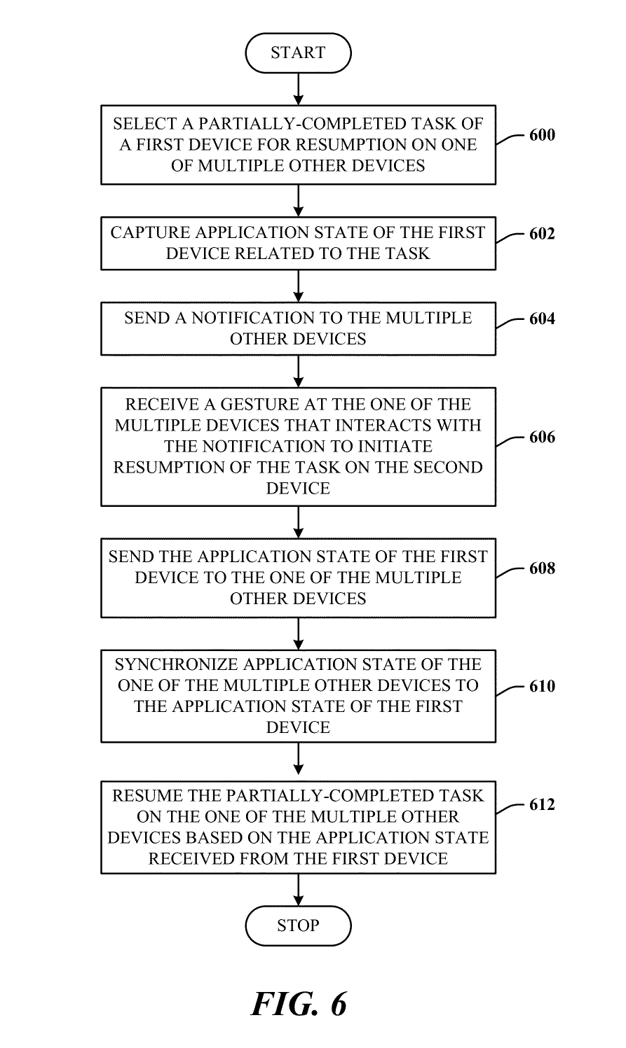

FIG. 6 illustrates an alternative method in accordance with the disclosed architecture. At 600, a partially-completed task of a first device is selected for resumption on one of multiple other devices. At 602, application state of the first device related to the task is captured. At 604, a notification is sent to the multiple other devices. At 606, a gesture is received at the one of the multiple devices that interacts with the notification to initiate resumption of the task on the second device. At 608, the application state of the first device is sent to the one of the multiple other devices. At 610, application state of the one of the multiple other devices is synchronized to the application state of the first device. At 612, the partially-completed task is resumed on the one of the multiple other devices based on the application state received from the first device.

The method can further comprise sending the application state of one or more applications of the first device to the one of the multiple devices via a network service. The method can further comprise sending the notification and the application state from the first device to the one of the multiple devices via short-range wireless communications connection or a cloud service. The method can further comprise automatically launching compatible applications of the one of the multiple devices and resuming the partially-completed task using the applications.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

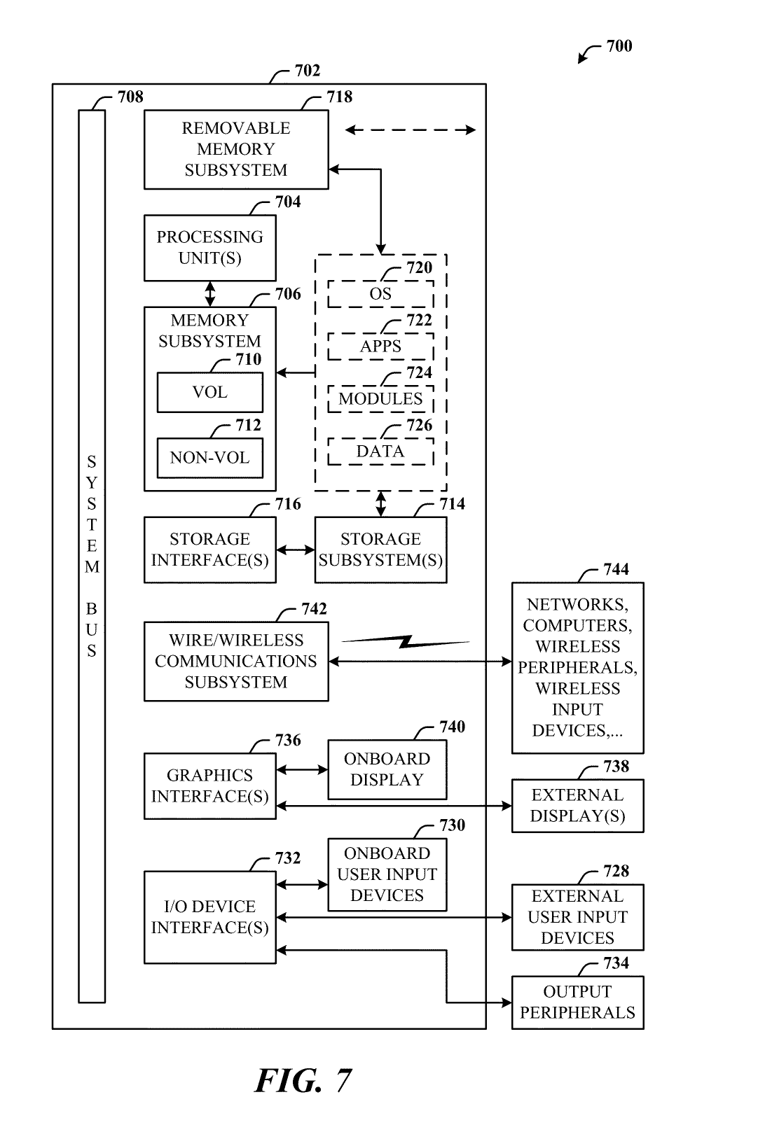

Referring now to FIG. 7, there is illustrated a block diagram of a computing system 700 that executes task continuation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, entities and flow of the example user interfaces 300 of FIG. 3, entities and components of the cloud service 400 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 702, and include volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a selection component that enables selection of a task of a first device to continue on a second device;
a state component that captures context state on the first device associated with the task based on the selection;
a notification component that sends a notification to the second device to continue the task;
a gesture component that interprets a received gesture to resume the task on the second device;
a synchronization component that synchronizes state of the second device to the context state to resume the task on the second device; and
at least one microprocessor that executes computer-executable instructions associated with each of the selection component, the notification component, the gesture component, the state component, and the synchronization component.

2. The system of claim 1, wherein the context state is captured locally in the first device and communicated via a network-based service to the second device.

3. The system of claim 1, wherein the context state is captured locally in the first device and communicated to the second device via a peer-to-peer connection.

4. The system of claim 1, wherein the context state is associated with multiple applications, and the multiple applications are launched on the second device to resume the task.

5. The system of claim 1, wherein the selection component automatically selects the task to be resumed on the second device.

6. The system of claim 1, wherein the gesture component recognizes the gesture as a natural user interface gesture to accept resumption of the task on the second device.

7. The system of claim 1, wherein the first device and the second device are associated by a login credential.

8. A method, comprising acts of:
selecting a task of a first device for continuation on a second device;
capturing context state of the first device related to the task;
sending a notification to the second device that enables the continuation of the task on the second device;
receiving a gesture at the second device that interacts with the notification to accept continuation of the task on the second device;
sending context state of the first device to the second device;
synchronizing state of the second device to the context state of the first device; and
resuming the task on the second device according to the context state.

9. The method of claim 8, further comprising capturing checkpoint context as the context state of the first device.

10. The method of claim 8, further comprising sending the context state from the first device to the second device via short-range wireless communications connection.

11. The method of claim 8, further comprising sending the context state and the notification to the second device via a network service.

12. The method of claim 8, further comprising recognizing the gesture as tactile contact with a touch display of the second device.

13. The method of claim 8, further comprising enabling automatic or manual selection of the task on the first device.

14. The method of claim 8, further comprising sending the notification to the second device and other devices of a user, the second device and the other devices associated with the first device by a user login identifier.

15. The method of claim 14, further comprising automatically logging in a client application of each of the first device, the second device and the other devices to a network service for sending the notification and the context state.

16. The method of claim 8, further comprising launching one or more applications on the second device that define the context state of the first device, and resume the task.

17. A computer-readable medium comprising computer-executable instructions that when executed by a processor, cause the processor to perform acts of:
selecting a partially-completed task of a first device for resumption on one of multiple other devices;
capturing application state of the first device related to the task;
sending a notification to the multiple other devices;
receiving a gesture at the one of the multiple devices that interacts with the notification to initiate resumption of the task on the second device;
sending the application state of the first device to the one of the multiple other devices;
synchronizing application state of the one of the multiple other devices to the application state of the first device; and
resuming the partially-completed task on the one of the multiple other devices based on the application state received from the first device.

18. The computer-readable medium of claim 17, further comprising sending the application state of one or more applications of the first device to the one of the multiple devices via a network service.

19. The computer-readable medium of claim 17, further comprising sending the notification and the application state from the first device to the one of the multiple devices via short-range wireless communications connection or a cloud service.

20. The computer-readable medium of claim 17, further comprising automatically launching compatible applications of the one of the multiple devices and resuming the partially-completed task using the applications.
